(19) United States
(12) Patent Application Publication
(10) Pub. No.: US 2017/0022857 A1
(43) Pub. Date: Jan. 26, 2017

(54) LOCKING CYLINDER PRESSURE RELIEF ACTUATOR

(71) Applicant: BorgWarner Inc., Auburn Hills, MI (US)

(72) Inventors: Matthew E. JUNKER, Cortland, NY (US); David C. WHITE, Dryden, NY (US); Michael CLOSE, Apalachin, NY (US)

(21) Appl. No.: 15/301,549

(22) PCT Filed: Mar. 25, 2015
(86) PCT No.: PCT/US2015/022354

§ 371 Date: Oct. 3, 2016

Related U.S. Application Data
(60) Provisional application No. 61/974,537, filed on Apr. 3, 2014.

(51) Int. Cl. F01L 13/08; F01L 1/18; F16H 21/44

(52) U.S. Cl. CPC F01L 13/08; F16H 21/44; F01L 1/185; F01L 2820/033

(57) ABSTRACT

A decompression assembly (12) and method can include a linkage mechanism (20), a biasing assembly (38) for normally biasing the linkage mechanism toward a locked position when an internal combustion engine (10) is in an unpowered state, and an actuating piston (44) for driving the linkage mechanism from the locked position toward the unlocked position when the engine (10) is in a powered state. The engine can include a cam lobe (70) for driving pivotal oscillation of a rocker arm (36) engageable with a valve (16) in the engine for movement between open and closed positions. The linkage mechanism allows a full range of movement of the rocker arm when in an unlocked position, and restricts movement of the rocker arm to less than a full range of movement when the linkage mechanism is in a locked position for maintaining the valve in a partially open position.

### FIELD OF THE INVENTION

The invention relates to a decompression device for a valve-controlled internal combustion engine.

### BACKGROUND

Decompression mechanisms can be employed in internal combustion engines for providing improved engine performance by opening valves to reduce compressive pressure of an air-fuel mixture in a cylinder located in the engine. Decompression mechanisms can reduce start torque at the start of an engine and can allow the air-mixture to be compressed at a higher pressure after the engine as been started. It can be desirable to implement a decompression mechanism in a vehicle having an automatic engine start and stop system because the mechanism can allow the engine to reach a minimal engine firing speed in a minimal amount of time in response to starting the engine. It can also be desirable to provide a decompression mechanism for increasing the durability of a starter by decreasing the starting load which can additionally reduce the noise vibration harshness during the start of the engine. Current decompression mechanisms can include accommodating decompression members such as rotatable decompression camshafts, exhaust cams, decompression pins, centrifugal weights, etc. for closing the valve and slightly opening the valve during the compression stroke of the cylinder. Decompression devices for valve-controlled internal combustion engines have been disclosed in U.S. Pat. No. 7,984,703; U.S. Pat. No. 7,621,247; U.S. Pat. No. 7,552,706; U.S. Pat. No. 7,263,960; U.S. Pat. No. 6,973,906; U.S. Pat. No. 6,895,918; and U.S. Pat. No. 6,837,203.

### SUMMARY

It can be desirable to avoid having an accommodating member and provide a simple structure insertable into the valve operating system and actuatable by fluid pressure already existing in the running engine. To overcome the limitation of current technology, the disclosed decompression assembly can include a linkage mechanism actuatable for allowing a valve to open slightly during the compression stroke of the cylinder cycle, when the engine is in an unpowered state, or allowing a valve to fully close when the engine is in a powered state. A decompression assembly can be used for a vehicle having an internal combustion engine operable in an unpowered and powered state. The engine can have at least one cylinder operable for an intake, compression, power, and exhaust stroke, a camshaft rotatable by a crankshaft and having a cam lobe, and a rocker arm engageable with the cam lobe. The cylinder can include a piston and a cylinder head having a valve and a valve biasing spring for normally biasing the valve in a closed position. The camshaft can be rotatable such that the cam lobe can engage the rocker arm for opening the valve.

The disclosed decompression assembly can include a linkage mechanism engageable with the rocker arm that can be operable in a locked position or unlocked position, when the cam lobe is disengaged with the rocker arm and the valve biasing spring is biasing the valve in the closed position. The linkage mechanism can allow upward movement of the rocker arm at predetermined distances when in the locked position and unlocked position. The rocker arm can allow upward movement of the valve to fully close in the unlocked position and can prevent upward movement of the valve to fully close in the locked position. The valve can be partially open in the locked position. The linkage mechanism can include a base fixedly secured to the cylinder head, a first support member, a second support member, and a third support member, and a first hinge pin, a second hinge pin, and a third hinge pin allowing pivoting movement about the hinged joints. Each support member can have a first and second end. The first end of the first support member can be connected to the base via the first hinge pin, the second end of the first support member can be connected to the first end of the second support member via the second hinge pin, and the first end of the third support member can be connected to the second end of the second support member via the third hinge pin. The first end of the second support member can be engaged by the actuating piston for collapsing the linkage mechanism from the locked position into the unlocked position. The second end of the third support member can engage the rocker arm. The decompression assembly can include a biasing assembly normally biasing the linkage mechanism in the locked position when the engine is in the unpowered state. The decompression assembly can further include an actuating piston for actuating the decompression assembly. The actuating piston can be actuatable by a source of fluid pressure for engaging the linkage mechanism and collapsing the linkage mechanism from the locked position into the unlocked position when the engine is in the powered state.

A method for providing pressure relief for at least one cylinder located in an internal combustion engine operable in an unpowered and powered state can include assembling a linkage mechanism operable between a locked position and an unlocked position allowing for opening and closing a valve, biasing the linkage mechanism toward the locked position, and actuating a fluid pressure operated reciprocal piston for driving the linkage assembly from the locked position to the unlocked position. The linkage mechanism can block upward movement of a rocker arm which can close the valve in the unlocked position and partially open the valve in the locked position. The linkage mechanism can include a base fixedly secured to a cylinder head, a first support member, a second support member, and a third support member, and a first hinge pin, a second hinge pin, and a third hinge pin allowing pivoting movement about the hinged joints. Each support member can have a first and second end. The first end of the first support member can be connected to the base via the first hinge pin, the second end of the first support member can be connected to the first end of the second support member via the second hinge pin, and the first end of the third support member can be connected to the second end of the second support member via the third hinge pin. The first end of the second support member can be engaged by the actuating piston for collapsing the linkage mechanism from the locked position into the unlocked position. The second end of the third support member can engage the rocker arm. The method can further include normally biasing the linkage mechanism toward the locked position when the engine is in the unpowered state. The method can further include fluid pressure actuating a piston for moving the linkage assembly from the locked position toward the unlocked position thereby activating the decompression assembly. The actuating piston can be moved in response to fluid communication with a source of fluid pressure for engaging the linkage mechanism and collapsing the linkage mechanism from the locked position into the unlocked position when the engine is in the powered state.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a simplified schematic of a linkage mechanism for a decompression assembly with the linkage mechanism illustrated in a locked position;

FIG. 2 is a simplified schematic of the linkage mechanism of FIG. 1 illustrating the linkage mechanism in an unlocked position;

FIG. 3 is a perspective sectional detailed view of the decompression assembly installed with respect to an internal combustion engine, illustrating the linkage mechanism in a locked position;

FIG. 4 is a perspective sectional detailed view of the linkage mechanism of FIG. 3 illustrating the linkage mechanism in an unlocked position; and

FIG. 5 is a simplified schematic of the linkage mechanism illustrating the locked position in solid lines and the unlocked position in phantom lines with the linkage mechanism operably engaging with a valve.

### DETAILED DESCRIPTION

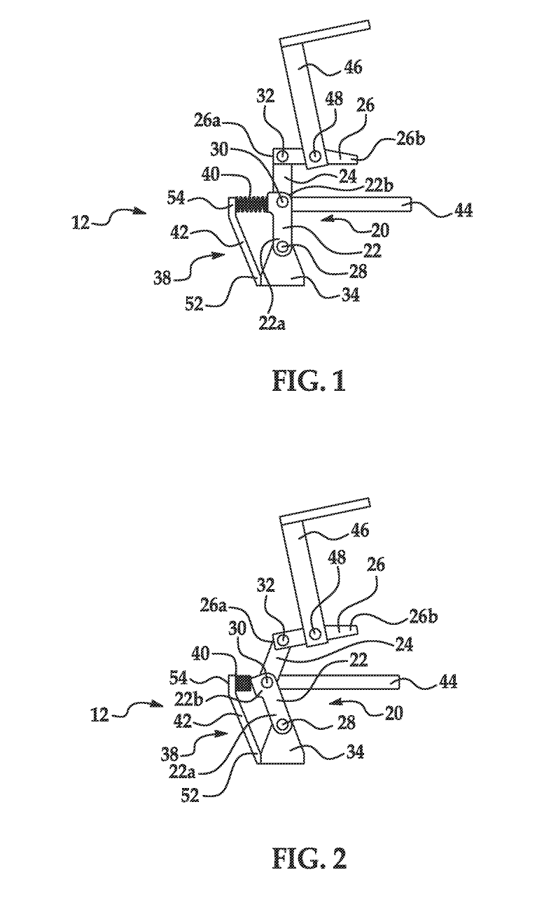

Referring now to FIGS. 1-5, a decompression assembly 12 can be used in a vehicle having an internal combustion engine 10 and including an automatic engine start and stop system. The engine 10 can be operable between an unpowered and powered state. The engine 10 can include a cylinder 14 operable in a cycle including an intake stroke, a compression stroke, an ignition/combustion/power stroke, and an exhaust stroke in various combinations as known for two-stroke-cycle and four-stroke-cycle operation of an engine. The cylinder 14 can include a piston and a cylinder head 68 having a valve 16. The engine 10 can include a plurality of cylinders having intake and exhaust valves. The cylinders can be operable for a two-stroke or four-stroke engine cycle. The engine 10 can include a camshaft 66 rotatable by a crankshaft driven in rotation by the engine 10 when the engine 10 is operating in the powered state. The camshaft 66 can have a cam lobe 70 engageable with a rocker arm 36, such that the cam lobe 70 can be operable for raising and lowering the rocker arm 36 for opening and closing the valve 16, respectively. The camshaft 66 can have a plurality of cam lobes. The four-stroke-cycle can refer to a path of travel of the piston as the piston progress through an intake stroke, a compression stroke, an ignition/combustion/power stroke, and an exhaust stroke, such that the cam lobe 70 can open the corresponding intake valve or exhaust valve to be controlled. During the intake stroke, the intake valve can be opened while the corresponding exhaust valve can be closed. During the intake stroke, the piston can descend from the top of a corresponding cylinder to the bottom of the cylinder, increasing the volume of the cylinder while drawing in and receiving a quantity of combustible fuel and air mixture. During the compression stroke, the piston can travel to the top of the cylinder for compressing combustible fuel and air mixture. During the ignition/combustion/power stroke, the compressed combustible fuel/air mixture can be ignited by a spark plug or glow plug, powering the piston to travel to the bottom of the cylinder. During the exhaust stroke, the piston can return to the top of the cylinder for expelling exhaust fumes from combustion of the combustible fuel air mixture through the exhaust valve. The intake valve can be closed during the compression, combustion, and exhaust strokes, while being open during the intake strokes. The corresponding exhaust valve can be closed during the intake, compression and combustion strokes, while being opened during the exhaust stroke. The decompression assembly 12 can be operable for opening and closing an intake valve or an exhaust valve. The improvement of a decompression assembly 12 can include a linkage mechanism 20, a biasing assembly 38, and an actuating piston 44. The linkage mechanism 20 can engage the rocker arm 36 in a locked position or an unlocked position. The linkage mechanism 20 can block or prevent full upward movement of the rocker arm 36 for partially closing the valve 16 when the linkage mechanism 20 is in the locked position thereby leaving the valve 16 partially open when the linkage mechanism 20 is in the locked position. The biasing assembly 38 can normally bias the linkage mechanism 20 toward the locked position when the engine 10 is in an unpowered state. The actuating piston 44 can engage the linkage mechanism 20 and can be actuatable for collapsing the linkage mechanism 20 from the locked position into the unlocked position when the engine is in a powered state allowing full upward movement of the rocker arm for completely closing the valve 16. The actuating piston 44 can be driven by an actuator 80, by way of example and not limitation, such as a pressurized fluid source 82 operable through a control valve 84 to place the pressurized fluid source 82 into fluid communication with the actuating piston 44 for driving the piston 44 toward the linkage mechanism 20 for driving movement of the linkage mechanism from the locked position toward the unlocked position when the engine 10 is in a powered state. The control valve 84 can be operated by a solenoid 86. It should be recognized by those skilled in the art that the actuating piston 44 could be directly operated by a solenoid actuator, if desired.

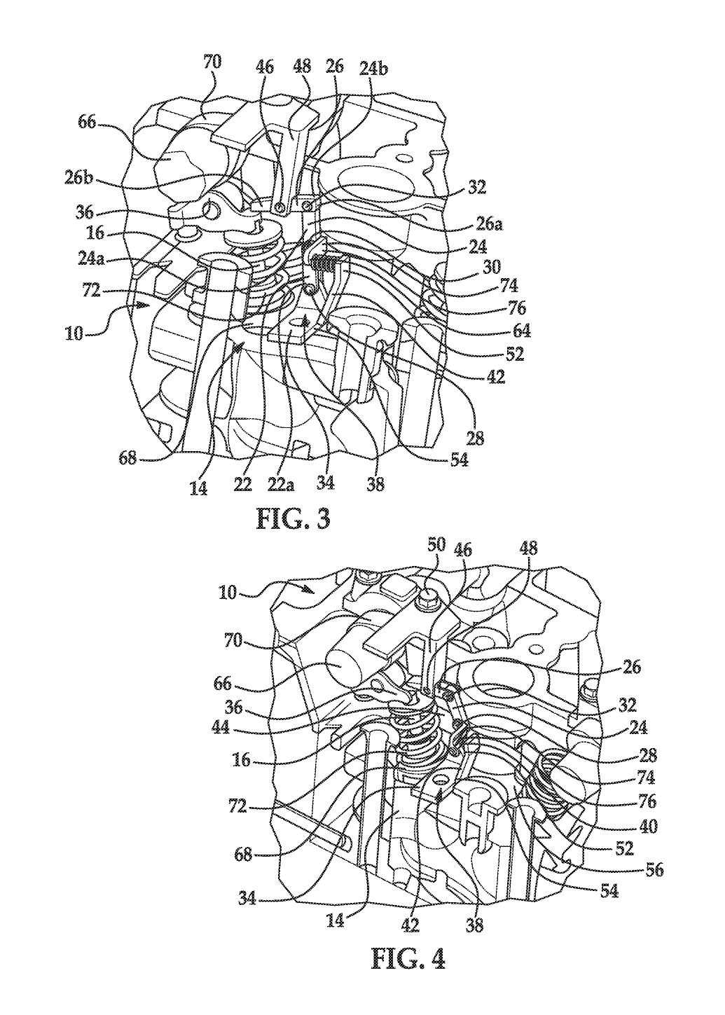

Referring now to FIGS. 1, 3, and 5, the linkage mechanism 20 can be operable in a locked position when the engine 10 is in an unpowered state. The unpowered state can include when the engine 10 is stopped or not running. The linkage mechanism 20 can include a base 34, a first support member 22, a second support member 24, and a third support member 26, a first hinge pin 28, a second hinge pin 30, and a third hinge pin 32. Each hinge pin 28, 30, 32 can allow pivoting movement about the hinge pin 28, 30, 32 defining a hinged joint. Each support member 22, 24, 26 can include a first and second end 22a, 22b; 24a, 24b; 24a, 24c. The first end 22a of the first support member 22 can be connected to the base 34 via the first hinge pin 28 allowing pivoting movement of the first end 22a with respect to the base 34. The second end 22b of the first support member 22 can be connected to the first end 24a of the second support member 24 via the second hinge pin 30 allowing pivoting movement of the first support member 22 and the second support member 24 with respect to one another. The first end 26a of the third support member 26 can be connected to the second end 24b of the second support member 24 via the third hinge pin 32 allowing pivoting movement of the second support member 24 and the third support member 26 with respect to one another. The first end 24a of the second support member 24 can be engaged by the actuating piston 44 for collapsing the linkage mechanism 20 from the locked position to the unlocked position. The second end 26b of the third support member 26 can engage the rocker arm 36. In the locked position, the first and second end 22a, 22b; 24a, 24b of the first and second support member 22, 24 can be substantially linearly aligned with respect to one another about the first hinge pin 28, while extending generally perpendicularly to the base 34 and the third support member 26, such that the third support member 26 operable engages with the rocker arm 36 to influence the opening and closing operation of the valve 16 depending on the locked or unlocked position of the linkage mechanism 20. As best illustrated in FIG. 3, the base 34 can be fixedly secured to the cylinder head 68. The base 34 can be secured in a position on the cylinder head 68, such that the linkage mechanism can be located adjacent to the valve 16 to be controlled. The decompression assembly 12 can further include a stationary bracket 46 having a first end fixedly secured to a support surface associated with the engine. The stationary bracket 46 can have a second end connected to the linkage mechanism 20 by a fourth hinge pin 48. As illustrated in FIGS. 1 and 3, the stationary bracket 46 can be connected to the third support member 26 with the fourth hinge pin 48. The base 34 and the stationary bracket 46 can secure the linkage mechanism 20 to the engine. It is contemplated that the stationary bracket 46 can be adjusted to mount the linkage mechanism 20 in various engine and cylinder configurations.

As illustrated in FIGS. 1 and 3, when the engine 10 is in the unpowered state, the linkage mechanism 20 is normally biased in the locked position by a biasing assembly 38 and the actuating piston is not activated. The biasing assembly 38 can include a fixed lever arm 42, a hinge flange 64, and a compression spring 40 interposed between the fixed lever arm 42 and the hinge flange 64. The fixed lever arm 42 can include a first end 54 for supporting the compression spring 40 and a second end 52 fixially secured to the base 34. As best illustrated in FIG. 3, the hinge flange 64 can include an end 74 secured to the second end 22b of the first support member 22, and a face 76 for supporting the compression spring 40. When the linkage mechanism 20 is in the locked position, the compression spring 40 extends between the face 76 and the fixed lever arm 42 to bias the second hinge pin 30 and connected first and second support members 22, 24 toward the locked position, thereby allowing the compression spring 40 through hinge flange 64 to lock the first hinge pin 28, second hinge pin 30 and third hinge pin 32 in a generally linear orientation with respect to one another preventing pivoting movement of the first and second support member 22, 24. The fixed lever arm 42 can be stationary and supports the compression spring 40 extending generally perpendicularly outwardly away from the first end 54 of the fixed lever arm 42. The linkage mechanism 20 can be formed of a stamped material such that the base 34 and fixed lever arm 42 can be a unitary assembly, each support member 22, 24, 26 can be a separate member, and the stationary bracket 46 can be a separate member. Each hinge joint can include a hinge pin 28, 30, 32 for connecting the separate members to form the structure of the linkage mechanism 20 as disclosed. The compression spring 40 can also be formed of a stamped material if desired.

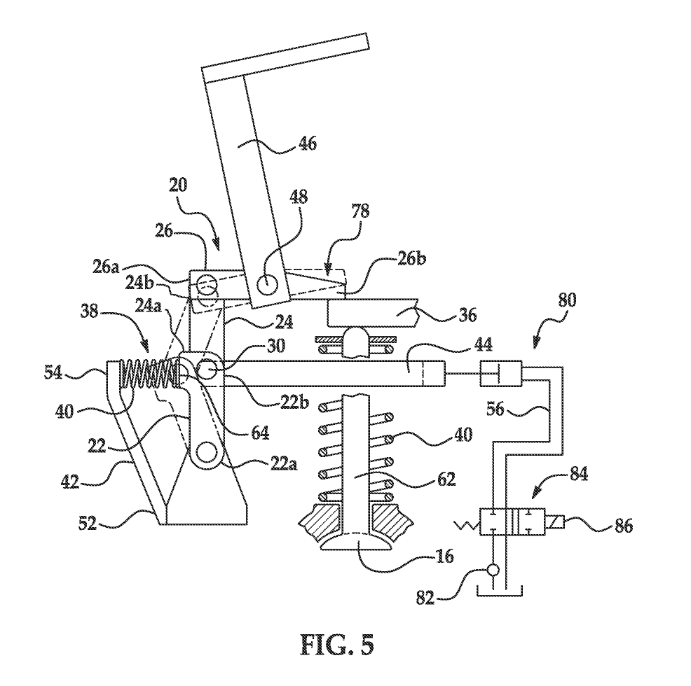

In operation, when the engine 10 is in the powered state, the crankshaft can rotate the camshaft 66 such that the cam lobe 70 can engage and disengage the rocker arm 36. The rocker arm 36 can open and close the corresponding intake or exhaust valve 16. The rocker arm 36 essentially acts as a cam follower spring biased against the cam lobe 70 by the valve biasing spring 72 which imparts biasing force and movement of the valve 16 toward a normally closed position of the valve. When the cam lobe 70 engages the rocker arm 36, the rocker arm 36 can force the valve 16 toward an open position acting against the valve biasing spring 72 for fully opening the valve 16. The rocker arm 36 can operate to fully open and close the valve 16, or to partially open and close the valve 16 depending in part on the position of the linkage mechanism 20. As best illustrated in FIGS. 3 and 5, when the linkage mechanism 20 is in the locked position, a bottom portion of the second end 26b of the third support member 26 can engage a top portion of the rocker arm 36 for blocking normal full movement of the rocker arm 36 preventing complete movement of the valve to the fully closed position, i.e. keeping the valve 16 partially open. When in a locked position of the linkage mechanism 20, the second end 26b of the third support member 26 is pivoted slightly about the third hinge pin 32 and into engagement with the rocker arm 36 limiting the normal range of movement of the rocker arm 36. Since rocker arm 36 is unable to accomplish a normal range of movement with the linkage mechanism 20 in the locked position, the rocker arm 36 is positioned spaced from the cam lobe 70 or in other words is disengaged with respect to the cam lobe 70, for at least part of the angular movement of the cam lobe 70. The valve biasing spring 72 normally biases the valve 16 for moving the valve 16 to the closed position in response to a normal range of movement for the rocker arm 36. When the range of movement of the rocker arm 36 is limited or impeded by the linkage mechanism, the range of movement is shortened and the valve biasing spring 72 is unable to completely close the valve 16. As best illustrated in FIG. 5, the third support member 26 can block the movement of the rocker arm 36 thereby limiting the normal range of movement of the rocker arm 36, such that the valve 16 having a valve stem 62 cannot move into a completely closed position to fully close the valve 16. The allowed range of movement of the rocker arm 36 can be a predetermined distance, allowing for the valve 16 to be partially open or “cracked open”. The partially opened valve 16 can allow the cylinder 14 to decompress when the engine 10 is in an unpowered state. When the engine enters a powered state of operation, the actuating piston 44 responds to fluid pressure of the engine to move the linkage mechanism from the locked position shown in solid line to the unlocked position shown in phantom allowing a full range of movement for the rocker arm 36 and consequently full closure of the valve 16.

Referring now to FIGS. 2, 4, and 5, the linkage mechanism 20 can be operable in an unlocked position when the engine 10 is in a powered state. As illustrated in FIG. 5 by phantom line representing an unlocked position 78, the linkage mechanism 20 can be collapsed into the unlocked position by action of the actuating piston 44. The powered state can include when the engine 10 has been ignited and reaches a pre-determined speed, or firing speed. When the engine 10 has reached a pre-determined speed, an actuator, by way of example and not limitation, piston 44 can be actuated to engage the linkage mechanism 20 driving the second hinge 30 to move the linearly aligned first and second support member 22, 24 out of linear alignment into an unlocked position. It is contemplated that the actuator can include, by way of example and not limitation, a source of fluid pressure or an electronic actuator. As best illustrated in FIG. 4, the actuator for actuating the piston 44 can include at least one fluid passage 56 in fluid communication between a fluid source and the actuating piston 44. The actuating piston 44 can be hydraulically actuatable by fluid pressure which can include oil pressure.

In operation, when the engine 10 is in a powered state and running at a pre-determined speed, or firing speed, oil can flow through at least one fluid passage 56 in fluid communication between the source of the oil and the actuating piston 44. The actuator 80 can include a control valve 84 operable for opening and closing the at least one fluid passage 56. Before the fluid pressure actuates the actuating piston 44, the linkage mechanism 20 is in the normally locked position and the actuating piston 44 is biased toward a disengaged position with respect to the linkage mechanism 20. Application of a pressurized fluid source 82 to the actuating piston 44 can drive the piston 44 in movement toward the linkage assembly 20 to move the second hinge pin 30 out of an aligned position with respect to the first and third hinge pins 28, 32. The actuating piston 44 can perpendicularly engage the linearly aligned first and second support member 22, 24, allowing the first and second support member 22, 24 to pivot about the second hinge 30. As best illustrated in FIG. 3, when the actuating piston 44 engages the first end 24a of the second support member 24, in corresponding movement, the first end 24a and the second end 22b of the first support member 22 can pivot about the second hinge 30 away from the actuating piston 44 and towards the biasing assembly 38 compressing the compression spring 40. The first end 22a of the first support member 22 can pivot about the first hinge 28 away from the actuating piston 44 and towards the biasing assembly 38. A hinge flange 64 can include an end 74 that can be secured to the second end 22b of the first support member 22. In response to pivoting of the second end 22b of the first support member 22, the second end 22b can move the hinge flange 64 toward the end 54 of first lever arm 42 compressing the compression spring 40 against the first end 54 of the fixed lever arm 42. The second end 24b of the second support member 24 can pivot about the third hinge pin 32 towards the biasing assembly 38. A stationary bracket 46 can be fixedly secured to a cam journal cap 50 located on the cylinder 16. The stationary bracket 46 can be hinged to the third support member 26 by a fourth hinge pin 48. In the collapsed or unlocked position, the third support member 26 can pivot about the third hinge pin 32 in toward the biasing assembly 38, as best seen in FIG. 5. As best illustrated in FIG. 5, the bottom portion of the second end 26b of the third support member 26 can engage the top portion of the rocker arm 36 for restricting movement of the rocker arm 36 to less than a full range of movement when in the locked position. As shown by the phantom line 78 in FIG. 5, the outer end 26b of the third support member 26 can away valve 16 when the linkage mechanism 20 is collapsed or unlocked, allowing a full range of movement of the valve 16 in order to reach a fully closed position during powered operation of the engine. In the collapsed or unlocked position, the third support member 26 can pivot allowing the valve 16 to be biased by the valve biasing spring 72 and move to the fully closed position and biasing the rocker arm 36 into continuous contact against the cam lobe.

A method of providing pressure relief for a cylinder 14 located in an internal combustion engine 10 operable between an unpowered state and a powered state is disclosed. The engine can include a valve 16 moveable between an opened position and a closed position in response to pivotal oscillating movement of a rocker arm 36 driven by rotation of a cam lobe 70. The method can include restricting pivotal oscillating motion of the rocker arm 36 to less than a full range of motion with a linkage mechanism 20 operable between a locked position allowing for only a diminished range of movement and an unlocked position allowing for full range of movement corresponding to completely opening and completely closing a valve 16. The method can further include biasing the linkage mechanism 20 toward a locked position with a biasing assembly 38, and actuating a piston 44 for collapsing the linkage mechanism 20 from the locked position to the unlocked position. The cylinder 14 can be operable through a four stroke cycle including an intake stroke, a compression stroke, an ignition/combustion/power stroke, and an exhaust stroke. The engine 10 can include a camshaft 66 driven in rotation by a crankshaft and having a cam lobe 70 engageable with a rocker arm 36. The cylinder 14 can include a piston and a cylinder head 68 having a valve 16 and a valve biasing spring 72 for normally biasing the valve 16 toward a closed position. The cam lobe 70 can pivotally oscillate the rocker arm 36 for driving the valve 16 between an open position and a closed position of the valve 16. The linkage mechanism 20 can restrict pivotal oscillating movement of the rocker arm 36 to a diminished range of movement less than a complete range of movement when the cam lobe 70 is allowing the rocker arm 36 to be driven by the biasing spring 40 in a direction closing the valve 16. The rocker arm 36 can close the valve 16 in the unlocked position, while leaving the valve 16 partially opening when the linkage mechanism 20 is in the locked position. The linkage mechanism 20 can include a base 34 fixedly secured to the cylinder head 68, a first support member 22, a second support member 24, a third support member 26, a first hinge pin 28, a second hinge pin 30, and a third hinge pin 32 allowing pivoting movement about the hinge pins 28, 30, 32. Each support member 22, 24, 26 can have a first end 22a, 24a, 26a and a second end 22b, 24b, 26b. The first end 22a of the first support member 22 can be connected to the base 34 via the first hinge pin 28. The second end 22b of the first support member 22 can be connected to the first end 24a of the second support member 24 via the second hinge pin 30. The first end 26a of the third support member 26 can be connected to the second end 24b of the second support member 24 via the third hinge 32. The first end 24a of the second support member 24 can be engaged by the actuating piston 44 for collapsing the linkage mechanism 20 from the locked position into the unlocked position. The second end 26b of the third support member 26 can engage the rocker arm 36. The biasing assembly 38 can normally bias the linkage mechanism 20 in the locked position when the engine 10 is in the unpowered state. The actuating piston 44 can engage the linkage mechanism 20 for collapsing the linkage mechanism 20 from the locked position into the unlocked position when the engine 10 is in the powered state.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. In an decompression assembly (12) for a vehicle having an internal combustion engine (10) operable between an unpowered state and a powered state, the engine (10) having a camshaft (66) with a cam lobe (70) engageable with a rocker arm (36) for driving a valve (16) between a closed position and an open position, a valve biasing spring (72) for normally biasing the valve (16) toward the closed position against the rocker arm (36), the improvement comprising:
a linkage mechanism (20) engageable with the rocker arm (36) and operable between a locked position and an unlocked position, the linkage mechanism (20) restricting pivotal movement of the rocker arm (36) to less than a complete range of motion when the linkage mechanism (20) is in the locked position, and allowing a complete range of motion for the rocker arm (36) when the linkage mechanism (20) is in the unlocked position, the linkage mechanism (20) holding the valve (16) in a partially open position when in the locked position;
a biasing assembly (38) normally biasing the linkage mechanism (20) toward the locked position when the engine (10) is in the unpowered state; and
an actuating piston (44) engageable with the linkage mechanism (20) for driving the linkage mechanism (20) from the locked position toward the unlocked position when the engine (10) is in the powered state.

2. The improvement of claim 1, wherein the linkage mechanism (20) further comprises:
a base (34) fixially secured to the engine (10);
a first support member (22), a second support member (24), and a third support member (26), each support member (22, 24, 26) having a corresponding first end (22a, 24a, 26a) and a corresponding second end (22b, 24b, 26b); and
a first hinge pin (28), a second hinge pin (30), and a third hinge pin (32) for allowing pivoting movement between connected support members (22, 24, 26), the first end (22a) of the first support member (22) connected to the base (34) with the first hinge pin (28), the second end (22b) of the first support member (22) connected to the first end (24a) of the second support member (24) with the second hinge pin (30), the first end (26a) of the third support member (26) connected to the second end (24b) of the second support member (24) with the third hinge pin (32), the first end (24a) of the second support member (24) engageable by the actuating piston (44) for collapsing the linkage mechanism (20) from the locked position into the unlocked position, the second end (26b) of the third support member (26) engageable with the rocker arm (36).

3. The improvement of claim 2, wherein the biasing assembly (38) further comprises:
a fixed lever arm (42) having a first end (54) and a second end (52) fixedly secured to the base (34);
a flange (64) having an end (74) secured to the second end (22a) of the first support member (22) and a face (76); and
a compression spring (40) interposed between the first end (54) and the face (76), the compression spring (40) biasing the linkage mechanism (20) toward the locked position and compressible when the linkage mechanism (20) is driven by the actuating piston toward the unlocked position.

4. The improvement of claim 1 further comprising:
a stationary bracket (46) fixedly secured to a cam journal cap (50) for securing the linkage mechanism (20) to the engine (10), the stationary bracket (46) supporting the linkage mechanism (20) for pivoting movement relative to the rocker arm (36).

5. The improvement of claim 1, wherein the valve (16) is on of an intake valve and an exhaust valve.

6. The improvement of claim 1 further comprising:
an actuator (80) for actuating the actuating piston (44) including at least one fluid passage (56) in fluid communication between a source of fluid pressure (82) and the actuating piston (44), the actuating piston (44) hydraulically actuatable by fluid pressure.

7. The improvement of claim 6, wherein the actuator for actuating the actuating piston (44) includes a control valve (84) operable for opening and closing the at least one fluid passage (56) between the source of fluid pressure (82) and the actuating piston (44).

8. The improvement of claim 1, wherein the actuator for actuating the actuating piston (44) includes a solenoid actuator (86).

9. A decompression assembly (12) for a vehicle having an internal combustion engine (10) operable between an unpowered state and a powered state, the engine (10) having a cam lobe (70) supported on a camshaft (66) for operating a valve (16) between an open position and a closed position, and a valve spring (72) for biasing the valve toward the closed position, the decompression assembly (12) comprising:
a rocker arm (36) engageable with the cam lobe (70), the cam lobe (70) engaging the rocker arm (36) for driving the valve (16) from the closed position toward the open position;
a linkage mechanism (20) engageable with the rocker arm (36) and operable between a locked position and an unlocked position, the linkage mechanism (20) restricting pivotal movement of the rocker arm (36) to less than a complete range of motion when the linkage mechanism (20) is in the locked position, and allowing a complete range of motion for the rocker arm (36) when the linkage mechanism (20) is in the unlocked position, the linkage mechanism (20) holding the valve (16) in a partially open position when in the locked position, the linkage mechanism (20) including a base (34), a first support member (22), a second support member (24), a third support member (26), a first hinge pin (28), a second hinge pin (30), and a third hinge pin (32), each support member (22, 24, 26) having a first end (22a, 24a, 26a) and a second end (22b, 24b, 26b), the first end (22a) of the first support member (22) pivotally connected to the base (34) with the first hinge pin (28), the second end (22b) of the first support member (22) pivotally connected to the first end (24a) of the second support member (24) with the second hinge pin (30), the first end (26a) of the third support member (26) pivotally connected to the second end (24b) of the second support member (24) with the third hinge pin (32), the second end (26b) of the third support member (26) engageable with the rocker arm (36);
a biasing assembly (38) normally biasing the linkage mechanism (20) toward the locked position, when the engine (10) is in the unpowered state; and
an actuating piston (44) for driving the linkage mechanism (20) toward the unlocked position, when the engine (10) is in the powered state, the actuating piston (44) driven by an actuator (80) and engageable with the first end (24a) of the second support member 24 for driving the linkage mechanism (20) from the locked position toward the unlocked position.

10. The decompression assembly (12) of claim 9 further comprising:
a stationary bracket (46) fixedly secured to a cam journal cap (50) for securing the linkage mechanism (20) to the engine (10), the stationary bracket (20) pivotally supporting the third support member (26) with a fourth hinge pin (48).

11. The decompression assembly (12) of claim 9, wherein the biasing assembly (38) further comprises:
a fixed lever arm (42) having a first end (54) and a second end (52) fixedly secured to the base (34);
a flange (64) having an end (74) secured to the second end (22a) of the first support member (22) and a face (76); and
a compression spring (40) interposed between the first end (54) of the fixed lever arm (42) and the face (76) of the flange (64), the compression spring (40) biasing the linkage mechanism (20) toward the locked position, and allowing movement of the linkage mechanism (20) toward the unlocked position in response to compression of the compression spring (40) by the actuating piston (44).

12. The decompression assembly (12) of claim 9, wherein the valve (16) is one of an intake valve and an exhaust valve.

13. The decompression assembly (12) of claim 9, wherein the actuator (80) for actuating the actuating piston (44) further comprises:
at least one fluid passage (56) in fluid communication between a pressurized fluid source (82) and the actuating piston (44); and
a control valve (84) operable for opening and closing the at least one fluid passage (56) for driving the actuating piston (44) toward the unlocked position of the linkage mechanism (20) when in fluid communication with the pressurized fluid source (82).

14. The decompression assembly (12) of claim 9, wherein the actuator (80) for actuating the actuating piston (44) further comprises an electronic actuator (86).

15. A method for providing pressure relief for a vehicle having an internal combustion engine (10) operable between an unpowered state and a powered state, the engine (10) having a camshaft (66) with a cam lobe (70) engageable with a rocker arm (36) for driving a valve (16) between a closed position and an open position, a valve biasing spring (72) for normally biasing the valve (16) toward the closed position against the rocker arm (36), the improvement comprising:
restricting pivotal movement of the rocker arm (36) to less than a complete range of motion with a linkage mechanism (20) when the linkage mechanism (20) is in a locked position;
allowing a complete range of motion for the rocker arm (36) when the linkage mechanism (20) is in an unlocked position;
holding the valve (16) in a partially open position with the linkage mechanism (20) when in the locked position;
normally biasing the linkage mechanism (20) toward the locked position with a biasing assembly (38) when the engine (10) is in the unpowered state; and
driving the linkage mechanism (20) from the locked position toward the unlocked position with an actuating piston (44) engageable with the linkage mechanism (20) when the engine (10) is in the powered state.
